(19) United States
(12) Patent Application Publication
(10) Pub. No.: US 2007/0234413 A1
(43) Pub. Date: Oct. 4, 2007

(54) Method for displaying customers with real-time feedback on firewall activity

(76) Inventors: Roger Borchers, Austin, TX (US); Shree A. Dandekar, Round Rock, TX (US)

Correspondence Address: HAMILTON & TERRILE, LLP, P.O. BOX 203518, AUSTIN, TX, 78720, US

(21) Appl. No.: 11/395,055

(22) Filed: Mar. 31, 2006

(51) Int. Cl. G06F 15/16

(52) U.S. Cl. 726/11

(57) ABSTRACT

A method for providing a user with feedback of firewall activity. The method includes determining when access to an application is attempted, blocking access of the application to the Internet based upon a blocked application list, and providing feedback to the user when access to an application is blocked by the firewall every time access to the application is blocked.

### BACKGROUND OF THE INVENTION

1. Field of the Invention

The present invention relates to the field of displaying customers with real-time instantaneous feedback on firewall activity.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known for information handling system manufacturers to preload information handling systems with firewall enabled solutions. With a firewall enabled information handling system, it often occurs that a customer, during the process of configuring the firewall, can make a choice to block an application without knowing the impact of that decision.

If a customer tries to use an application that tries to make an outbound connection and has not been white-listed by the firewall, the customer is often prompted regarding whether to block or allow application. If the customer mistakenly decides to block, known firewalls do not provide feedback when an application is being blocked. Once an application is blocked by the firewall, each subsequent time a user tries to use the application, it fails to execute due to the blocking by the firewall. The firewall does not notify the user that the application was black listed (i.e., was blocked).

In usability, the concept of feedback is important so users know when something has occurred or taken effect. If a user started an application, received some feedback from the firewall that the application was being blocked, and then noticed the application did not work, the user would be able to correlate the firewall blocking with the application failure. A large percentage of firewall related support calls are due to incorrect decisions to block applications such as Internet Explorer. One reason current firewalls do not implement a feedback feature, is that the firewalls need to be extremely fast to not inhibit network traffic.

It would be desirable to provide a firewall with a method of providing real time feedback of firewall activity.

### SUMMARY OF THE INVENTION

In accordance with the present invention, a method for providing a firewall with feedback of firewall activity is set forth. The feedback is provided in real time and substantially instantaneous with the firewall activity. The feedback is provided to the customers on applications that are blocked by the firewall every time access to the application is attempted. The method makes use of a listener pattern to determine when to provide the feedback. The listener pattern separates the process of application filtering and the process of notification. By providing the feedback on firewall activity, support calls to the information handling system manufacturer are reduced.

In one embodiment, the invention relates to a method for providing a user with feedback of firewall activity. The method which includes determining when access to an application is attempted, blocking access of the application to the Internet based upon a blocked application list, and providing feedback to the user when access to an application is blocked by the firewall every time access to the application is blocked.

In another embodiment, the invention relates to an apparatus for providing a user with feedback of firewall activity. The apparatus includes means for determining when access to an application is attempted, means for blocking access of the application to the Internet based upon a blocked application list, and means for providing feedback to the user when access to an application is blocked by the firewall every time access to the application is blocked.

In another embodiment, the invention relates to an information handling system for providing a user with feedback of firewall activity. The information handling system includes a processor, memory coupled to the processor, an application stored on the memory and a firewall application stored on the memory. The firewall application includes instructions for determining when access to the application is attempted, blocking access of the application to the Internet based upon a blocked application list, and providing feedback to the user when access to an application is blocked by the firewall every time access to the application is blocked.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a schematic diagram of a system for installing software.

FIG. 2 shows a schematic block diagram of an information handling system having a firewall application prequalification system.

FIG. 3 shows a flow chart of the operation of a system for providing customers with feedback on firewall activity.

FIG. 4 shows a block diagram of a listener class diagram.

FIG. 5 shows a screen presentation of the system for providing feedback on firewall activity.

FIG. 6 shows a screen presentation of the system for providing feedback on firewall activity.

### DETAILED DESCRIPTION

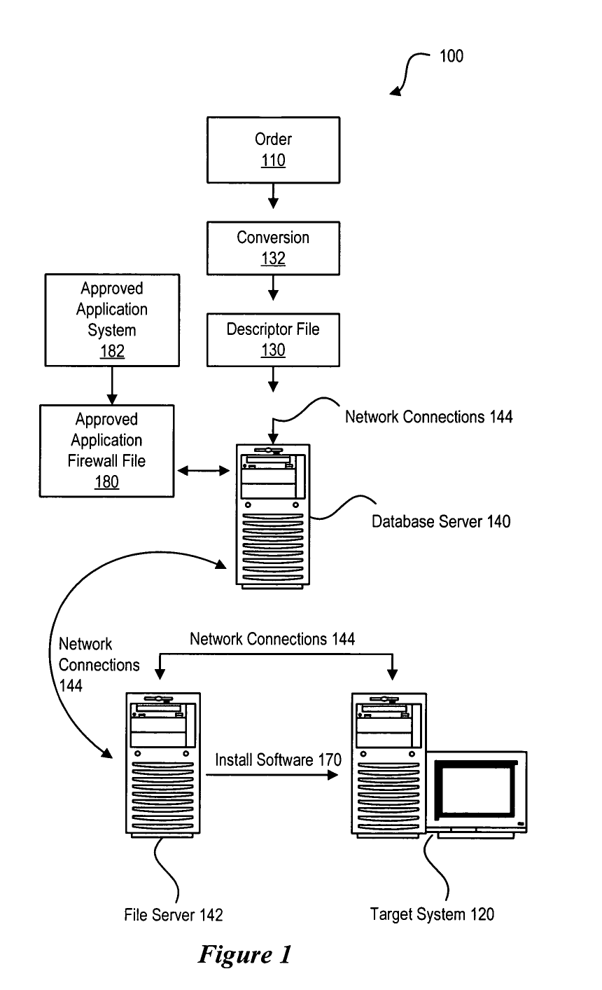

FIG. 1 is a schematic diagram of a software installation system 100 at an information handling system manufacturing site. In operation, an order 110 is placed to purchase a target information handling system 120. The target information handling system 120 to be manufactured contains a plurality of hardware and software components. For instance, target information handling system 120 might include a certain brand of hard drive, a particular type of monitor, a certain brand of processor, and software. The software may include a particular version of an operating system along with all appropriate driver software and other application software along with appropriate software bug fixes. The software may also include firewall software. Before target information handling system 120 is shipped to the customer, the plurality of components are installed and tested. Such software installation and testing advantageously ensures a reliable, working information handling system which is ready to operate when received by a customer.

Because different families of information handling systems and different individual computer components may require different software installations, it is desirable to determine which software to install on a target information handling system 120. A descriptor file 130 is provided by converting an order 110, which corresponds to a desired information handling system having desired components, into a computer readable format via conversion module 132.

Component descriptors are computer readable descriptions of the components of target information handling system 120 which components are defined by the order 110. In one embodiment, the component descriptors are included in a descriptor file called a system descriptor record which is a computer readable file containing a listing of the components, both hardware and software, to be installed onto target information handling system 120. Having read the plurality of component descriptors, database server 140 provides an image having a plurality of software components corresponding to the component descriptors to file server 142 over network connection 144. Network connections 144 may be any network connection well-known in the art, such as a local area network, an intranet, or the internet. The information contained in database server 140 is often updated such that the database contains a new factory build environment. The software is then installed on the target information handling system 120 via file server 142. The software is installed on the target information handling system via the image. The image may include self-configuring code.

The database server 140 may also be provided with an approved application firewall file 180. The approved application firewall file 180 identifies to the installed firewall software a list of those applications that are installed during the manufacture of the target system 120 and are thus presumed safe from the standpoint of the firewall software.

An approved application system 182 dynamically generates the approved application firewall file 180 based upon applications that are to be installed on an individual target system 120. The applications that are to be installed may be derived from the descriptor file 130. Thus, the approved application firewall file 180 sets forth applications that a firewall application should enable access to the internet by default. The system 182 includes the assumption that applications installed during the factory install process are safe and have not had a chance to be modified by a Trojan since the machine has not yet been connected to the internet.

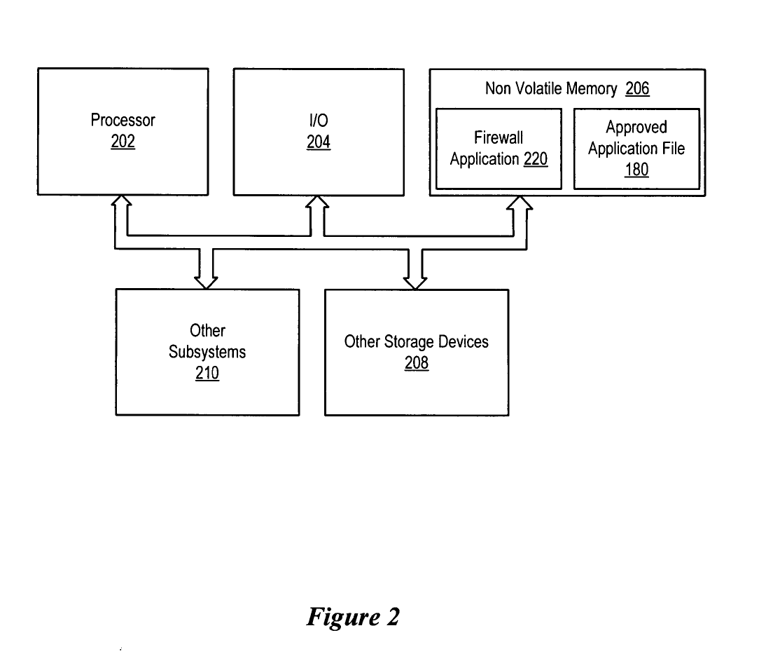

Referring to FIG. 2, a system block diagram of a target information handling system 120 is shown. The information handling system 120 includes a processor 202, input/output (I/O) devices 204, such as a display, a keyboard, a mouse, and associated controllers, memory 206 including non-volatile memory such as a hard disk drive 206 and volatile memory such as random access memory, and other storage devices 208, such as a CD-ROM or DVD disk and drive and other memory devices, and various other subsystems 210, all interconnected via one or more buses, shown collectively as bus 312. A firewall application 220 is stored on the memory 306 of the information handling system 120 and is executed by the processor 202 of the information handling system 120. The information handling system 120 also includes the approved application file 180 stored on the memory. The approved application file 180 interacts with the firewall application 220 to indicate applications that are identified as approved for access via the firewall application 220.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

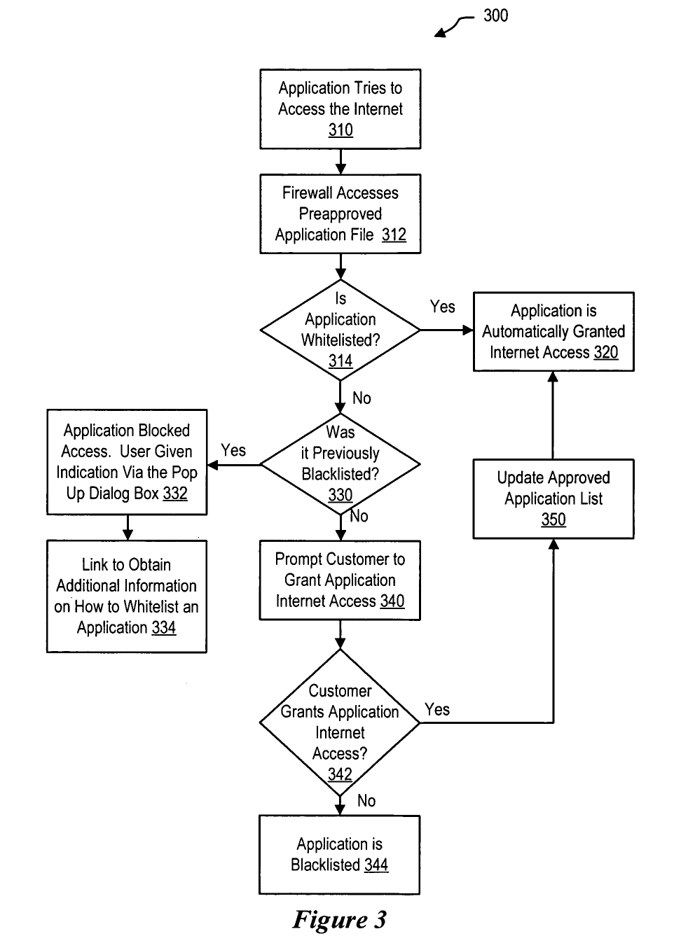

FIG. 3 shows a flow chart of the operation of a system for providing feedback on firewall activity 300. The system for providing feedback on firewall activity 300 starts execution when an application attempts to access the Internet at step 310. The firewall application 220 accesses the preinstalled approved application file 180 at step 312 an determines whether the application is white listed (i.e., is preapproved) at step 314. If the application was preapproved, then the application is granted Internet access at step 320.

If the application was not white listed, then the firewall application 220 determines whether the application was previously blacklisted at step 330. If the application was previously blacklisted, then the firewall blocks application access at step 332 and an indication of the blocking is provided, e.g., via a pop up dialog box. The dialog box enables a user to actuate a link to obtain additional help documentation of how to whitelist an application at step 334.

If the application was not previously blacklisted, then the firewall application 220 prompts the user about whether to grant the application Internet access at step 340. The firewall application 220 determines whether such access is granted at step 342. If access is not granted, then the application is blacklisted (i.e., added to a list of blocked applications) at step 344. If access is granted, then the firewall updates the approved application list at step 350 and the application is granted access to the Internet at step 320.

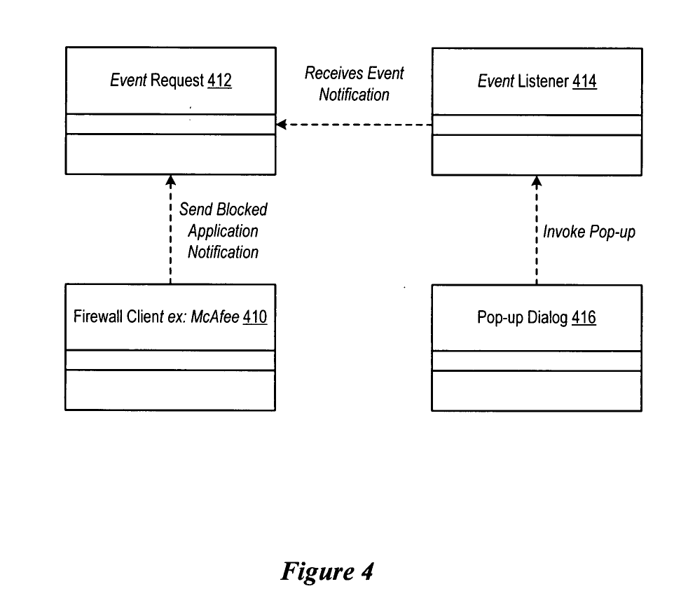

FIG. 4 shows a block diagram of a listener class diagram. More specifically, the system for providing feedback on firewall activity 300 includes a firewall client module 410, an event request module 412, an event listener module 414 and a pop up dialog module 416. The firewall client module 410 provides the capability to create and send messages. Every time a user attempts to execute a blocked application, the firewall client module 410 accesses the black listed applications file. If the application is blocked, then the firewall client module 410 sends a block notification to the event listener module 414. The event request module 412 is the event object created by the firewall client module 410 and sent to the event listener module 414. The event listener module 414 implements an onMessage( ) method that is invoked with a new message arrives. The listener module 414 parses (i.e., unmarhsals) the event (i.e., the request) using the lookup table to determine what application was blocked. The pop up dialog module 416 is the target object that gets invoked by the event listener module 414.

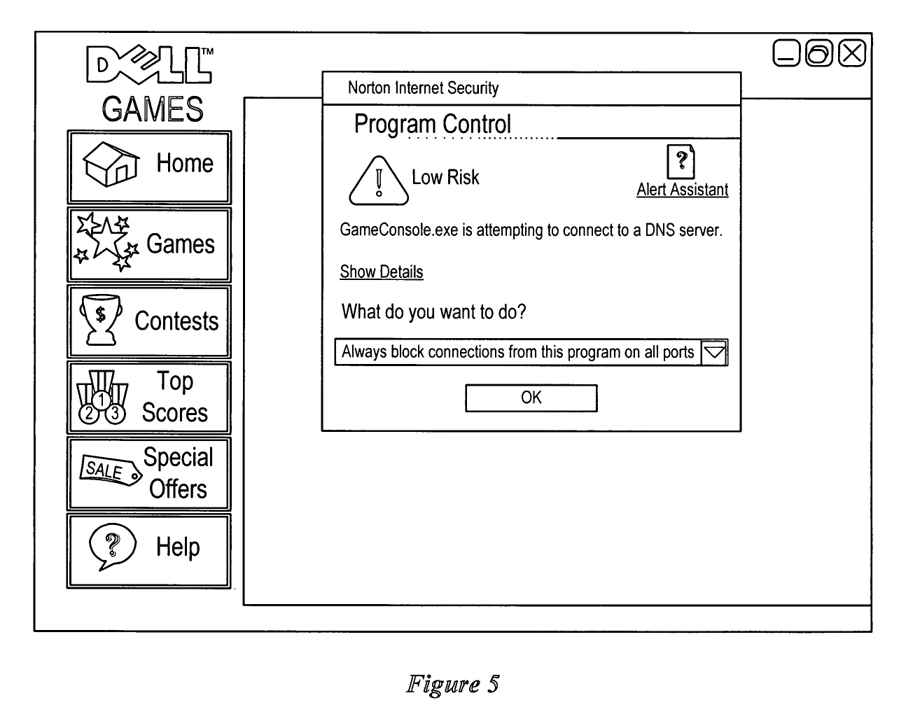

FIG. 5 shows a screen presentation of the system for providing feedback on firewall activity. For example, if a user attempts to download a game from a gaming console, the firewall application 220 detects the outbound access request and prompts a user about whether the user wishes to grant access. If the user selects to block access, then the attempted access is added to the black list.

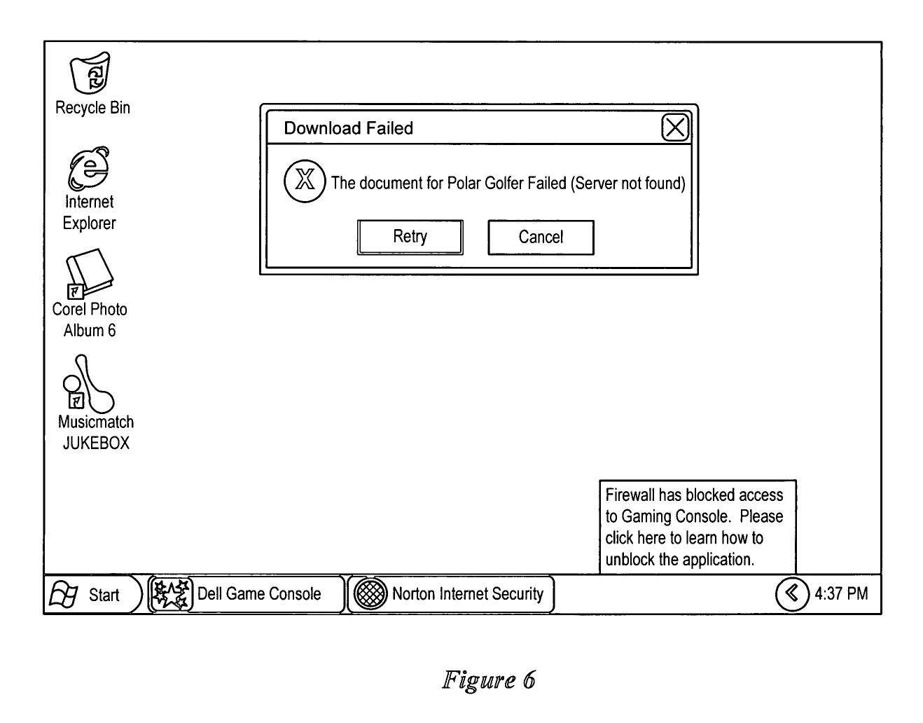

FIG. 6 shows a screen presentation of the system for providing feedback on firewall activity. More specifically, when a user attempts to redownload the game from the gaming console, the application fails to connect to the internet because the application has been black listed by the firewall application. The firewall application 220 presents a dialog box that informs the user that the firewall application blocked access t the application. The user can actuate the help link to access product documentation of how to unblock the application.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Also, for example, the system for providing feedback on firewall activity may use other methods in addition to listening for identifying applications that are blocked. For example, a firewall might generate a log file and log application blocking. The system for providing feedback can continuously or regularly (i.e., in a scheduled manner) poll the log file to check for changes or new entries to the log file.

Consequently, the invention is intended to be limited only by the spirit and scope of the appended claims, giving full cognizance to equivalents in all respects.

What is claimed is:

1. A method for providing a user with feedback of firewall activity comprising:
determining when access to an application is attempted;
blocking access of the application to the Internet based upon a blocked application list;
providing feedback to the user when access to an application is blocked by the firewall every time access to the application is blocked.

2. The method of claim 1 wherein:
using a listener pattern to determine when to provide the feedback, the listener pattern separating application filtering and notification.

3. The method of claim 1 wherein:
the feedback is provided in real time and substantially instantaneous with the firewall activity.

4. The method of claim 1 further comprising:
generating a list of approved applications based upon software installed on the information handling system during manufacture of the information handling system;
granting access to the application when the application is on the list of approved applications.

5. The method of claim 4 wherein:
the list of approved applications is preinstalled on the information handling system during the manufacture of the information handling system.

6. The method of claim 4 wherein:
the software that is installed on the information handling system during manufacture of the information handling system is installed based upon a specific customer order.

7. An apparatus for providing a user with feedback of firewall activity comprising:
means for determining when access to an application is attempted;
means for blocking access of the application to the Internet based upon a blocked application list;
means for providing feedback to the user when access to an application is blocked by the firewall every time access to the application is blocked.

8. The apparatus of claim 7 further comprising:
means for using a listener pattern to determine when to provide the feedback, the listener pattern separating application filtering and notification.

9. The apparatus of claim 7 wherein:
the feedback is provided in real time and substantially instantaneous with the firewall activity.

10. The apparatus of claim 7 further comprising:
means for generating a list of approved applications based upon software installed on the information handling system during manufacture of the information handling system;
means for granting access to the application when the application is on the list of approved applications.

11. The apparatus of claim 10 wherein:
the list of approved applications is preinstalled on the information handling system during the manufacture of the information handling system.

12. The apparatus of claim 10 wherein:
the software that is installed on the information handling system during manufacture of the information handling system is installed based upon a specific customer order.

13. An information handling system for providing a user with feedback of firewall activity comprising:
a processor;
memory coupled to the processor,
an application stored on the memory;
a firewall application stored on the memory, the firewall application including instructions for
determining when access to the application is attempted;
blocking access of the application to the Internet based upon a blocked application list;
providing feedback to the user when access to an application is blocked by the firewall every time access to the application is blocked.

14. The information handling system of claim 13 wherein the firewall application includes instructions for:
using a listener pattern to determine when to provide the feedback, the listener pattern separating application filtering and notification.

15. The information handling system of claim 13 wherein:
the feedback is provided in real time and substantially instantaneous with the firewall activity.

16. The information handling system of claim 13:
a list of approved applications is generated based upon software installed on the information handling system during manufacture of the information handling system;
the firewall application grants access to the application when the application is on the list of approved applications.

17. The information handling system of claim 16 wherein:
the list of approved applications is preinstalled on the information handling system during the manufacture of the information handling system.

18. The information handling system of claim 16 wherein:
the software that is installed on the information handling system during manufacture of the information handling system is installed based upon a specific customer order.
